(19) United States
(12) Patent Application Publication
(10) Pub. No.: US 2024/0406745 A1
(43) Pub. Date: Dec. 5, 2024

(54) INTERFERENCE AVOIDANCE FOR HIGH DENSITY AD HOC NETWORKS

(71) Applicant: Dell Products, L.P., Round Rock, TX (US)

(72) Inventors: Harpreet Narula, Austin, TX (US); Arnold Thomas Schnell, Hutto, TX (US); Nicholas Wanner, Austin, TX (US)

(73) Assignee: Dell Products, L.P., Round Rock, TX (US)

(21) Appl. No.: 18/325,177

(22) Filed: May 30, 2023

(51) Int. Cl. H04W 16/14; H04W 52/36

(52) U.S. Cl. CPC H04W 16/14; H04W 52/367; H04W 84/12; H04W 84/18

(57) ABSTRACT

Implementing interference avoidance for high density ad hoc networks may include creating ad hoc Wireless Local Area Network (WLAN) clusters (WLAN pico-nets) of Information Handling Systems (IHSs) with nonoverlapping channels, enabling each IHS to have a high bandwidth wireless interface, and isolating nearby ad hoc WLAN clusters, using a Basic Secure Set (BSS) color field to associate IHSs within an ad hoc WLAN cluster (which may be preconfigured for each ad hoc WLAN cluster). Physical separation of ad hoc WLAN clusters may be optimized, minimizing cochannel interference, such as through use of dynamic threshold calculations. Nearby ad hoc WLAN clusters may be further isolated by dynamically adjusting transmit power control to isolate nearby ad hoc WLAN clusters, and/or by scaling channel width, such as through Dynamic Throughput Scalar calculations.

### FIELD

This disclosure relates generally to Information Handling Systems (IHSs), and, more specifically, to interference avoidance for high density ad hoc networks.

### BACKGROUND

As the value and use of information continues to increase, individuals and businesses seek additional ways to process and store information. One option available to users is information handling systems. An Information Handling System (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated.

The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

“Hoteling” is a method of office management in which workers dynamically schedule their use of workspaces such as desks, cubicles, and offices, as well resources associated therewith such as (an) IHS monitor(s), keyboard, mouse, webcam, etc., particularly where a hybrid, partial remote and partial in-office, work model is employed by an enterprise. Such hybrid office workspaces may make use of wireless IHS docking stations (“dock”) and portable IHSs (e.g., laptops) wirelessly linked thereto. Each wireless dock results in an additional Wireless Local Area Network (WLAN) link which is in addition to the WLAN link from Access Points (APs) in the enterprise environment. A sample hybrid office space may have, by way of example, 230 seats within wireless range. High bandwidth needs for video data over a WLAN link, typically require a 160 MHz link. Thus, a maximum of twelve non-overlapping channels may be available in this hybrid office space example, assuming complete bandwidth is available. Still the number of concurrent channels needed is much higher for typical hybrid workspace seating.

One typical solution is to reduce the transmit (Tx) power of the radio on both sides of the link. However, limited controls are available in typical IHS operating systems. Additionally applying such Tx power limits also limit device connectivity with infrastructure and challenges the signal-to-noise ratio (SNR) of the signal in such a high-interference environment.

### SUMMARY

Embodiments of interference avoidance for high density ad hoc networks are described. In an illustrative, non-limiting example ad hoc Wireless Local Area Network (WLAN) clusters (WLAN pico-nets) of Information Handling Systems (IHSs) with nonoverlapping channels are created, each IHS having a high bandwidth wireless interface, and nearby ad hoc WLAN clusters are isolated using a Basic Secure Set (BSS) color field to associate IHSs within an ad hoc WLAN cluster. The BSS color may be preconfigured for each ad hoc WLAN cluster.

In accordance with some aspects of the present systems and methods, physical separation of ad hoc WLAN clusters may be optimized to minimize cochannel interference, such as by using dynamic threshold calculations that enable overlap in channels of different ad hoc WLAN clusters enabling IHSs to operate without randomly backing off.

In accordance with some further aspects of the present systems and methods, isolating nearby ad hoc WLAN clusters may include dynamically adjusting transmit power control to isolate nearby ad hoc WLAN clusters. This transmit power control may include advertising a maximum transmit power in ad hoc WLAN cluster management frames, requesting, by an ad hoc WLAN cluster node IHS, a transmit power control report element, and transmitting in accordance with transmit power control report element. The ad hoc WLAN cluster management frames may be a beacons, probe responses and/or the like. Ad hoc WLAN cluster management frame statistics obtained thereby may be held on a per associated ad hoc WLAN cluster node IHS basis. In accordance with various aspects the control and management frames are sent using a highest allowable transmit power level, the transmit power control report element may include a frame that holds information about the transmit power and a link margin, and/or the like. In accordance with such aspects, transmit power control does not involve an operating system (OS) of the ad hoc WLAN cluster node IHS(s), transmit power control is dynamically managed based on environmental conditions, etc.

In accordance with some still further aspects of the present systems and methods, isolating nearby ad hoc WLAN clusters may further include scaling channel width, such as through a Dynamic Throughput Scalar (DTS) calculation.

In accordance with the foregoing, a non-transitory computer readable medium, or the like may have instructions stored thereon that, upon execution by one or more IHSs, may cause the one or more IHSs to create ad hoc WLAN clusters of IHSs with nonoverlapping channels, enable each IHS to have a high bandwidth wireless interface, isolate nearby ad hoc WLAN clusters using a BSS color field to associate IHSs within an ad hoc WLAN cluster, optimize physical separation of ad hoc WLAN clusters to minimize cochannel interference, and (further) isolate nearby ad hoc WLAN clusters by dynamically adjusting transmit power control.

Thusly, an IHS having at least one processor and a memory coupled to the processor(s) with program instructions stored thereon that, upon execution by the processor(s), cause the IHS to implement interference avoidance in a high density ad hoc network. For example, the IHS joins an ad hoc WLAN cluster of IHSs with nonoverlapping channels, isolated from other nearby ad hoc LAN clusters by a BSS color field associating IHSs within the ad hoc WLAN cluster, optimizing physical separation of the ad hoc WLAN clusters to minimize cochannel interference by using dynamic threshold calculations, and (further) isolating nearby ad hoc WLAN clusters by dynamically adjusting transmit power control. The IHS(s) may also isolate nearby ad hoc WLAN clusters by scaling channel width.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram illustrating components of an example of an Information Handling System (IHS), according to some embodiments.

FIG. 2 is a block diagram showing key components of a hybrid workspaces office space, according to some embodiments.

FIG. 3 is a diagrammatic illustration of an example hybrid workspace office space, showing seats within an example wireless local area network range.

FIG. 4 is a diagrammatic illustration of an example set of Wireless Local Area Network (WLAN) pico-nets, employed according to various embodiments of the present systems and methods.

FIG. 5 a diagrammatic illustration of a high efficiency operation element that includes an example Basic Secure Set (BSS) color information field, according to some embodiments.

FIG. 6 is a diagrammatic illustration of the example hybrid workspace office space of FIG. 3, showing multi-channel interference avoidance for high density ad hoc networks using BSS color, according to some embodiments.

FIG. 7 is a flowchart of an example process for interference avoidance for high density ad hoc networks, according to some embodiments.

FIG. 8 is a diagrammatic illustration of Fine Timing Management (FTM) enabled in IEEE 802.11ax (Wi-Fi® 6(E)).

FIG. 9 is a diagrammatic illustration of an example implementation of dynamic threshold calculation, according to some embodiments.

FIG. 10 is a flowchart of an example of dynamic sensitivity control, such as may be derived using FTM, inter-channel BSS and intra-channel BSS, from FIGS. 8 and 9, according to some embodiments.

### DETAILED DESCRIPTION

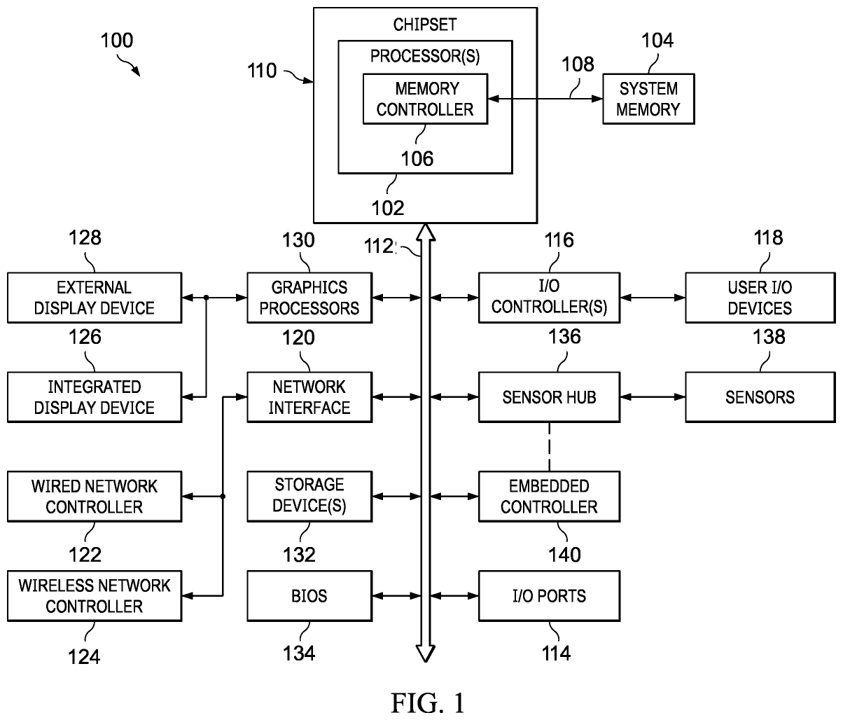

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, in accordance with embodiments of the present systems and methods, an IHS may be a personal computer (e.g., laptop), tablet computer, mobile device (e.g., personal digital assistant (PDA) or smart phone), a wireless docking station, conference room equipment, such as, by way of example video bar, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components. A more detailed example of an IHS is described with respect to FIG. 1.

FIG. 1 is a block diagram of an example of internal components of IHS 100, according to some embodiments. As shown, IHS 100 includes one or more processors 102, such as a Central Processing Unit (CPU), that execute code retrieved from system memory 104. Although IHS 100 is illustrated with a single processor 102, other embodiments may include two or more processors, that may each be configured identically, or to provide specialized processing operations. Processor(s) 102 may include any processor capable of executing instructions, such as an Intel Pentium™ series processor or any general-purpose or embedded processors implementing any of a variety of Instruction Set Architectures (ISAs), such as the x86, POWERPC®, ARM®, SPARC®, or MIPS® ISAs, or any other suitable ISA.

In the embodiment of FIG. 1, processor(s) 102 includes memory controller 106 that may be implemented directly within the circuitry of processor(s) 102, or memory controller 106 may be a separate integrated circuit that is located on the same die as processor(s) 102. Memory controller 106 may be configured to manage the transfer of data to and from the system memory 104 of IHS 100 via high-speed memory interface 108. System memory 104 coupled to processor(s) 102 provides processor(s) 102 with a high-speed memory that may be used in the execution of computer program instructions by processor(s) 102. Accordingly, system memory 104 may include memory components, such as static RAM (SRAM), dynamic RAM (DRAM), NAND Flash memory, suitable for supporting high-speed memory operations by processor(s) 102. In certain embodiments, system memory 104 may combine both persistent, non-volatile memory and volatile memory. In certain embodiments, system memory 104 may include multiple removable memory modules.

IHS 100 utilizes chipset 110 that may include one or more integrated circuits that are connected to processor(s) 102. In the embodiment of FIG. 1, processor(s) 102 is depicted as a component of chipset 110. In other embodiments, all of chipset 110, or portions of chipset 110 may be implemented directly within the integrated circuitry of processor(s) 102. Chipset 110 provides processor(s) 102 with access to a variety of resources accessible via bus 112. In IHS 100, bus 112 is illustrated as a single element. Various embodiments may utilize any number of separate buses to provide the illustrated pathways served by bus 112.

In various embodiments, IHS 100 may include one or more I/O ports 114 that may support removeable couplings with various types of external devices and systems, including removeable couplings with peripheral devices that may be configured for operation by a particular user of IHS 100. For instance, I/O ports 114 may include USB (Universal Serial Bus) ports, by which a variety of external devices may be coupled to IHS 100. In addition to or instead of USB ports, I/O ports 114 may include various types of physical I/O ports that are accessible to a user via the enclosure of IHS 100.

In certain embodiments, chipset 110 may additionally utilize one or more I/O controllers 116 that may each support the operation of hardware components such as user I/O devices 118 that may include peripheral components physically coupled to I/O port 114 and/or peripheral components that are wirelessly coupled to IHS 100 via network interface 120. In various implementations, I/O controller 116 may support the operation of one or more user I/O devices 118 such as a keyboard, mouse, touchpad, touchscreen, microphone, speakers, camera and other input and output devices that may be coupled to IHS 100. User I/O devices 118 may interface with an I/O controller 116 through wired or wireless couplings supported by IHS 100. In some cases, I/O controllers 116 may support configurable operation of supported peripheral devices, such as user I/O devices 118.

As illustrated, a variety of additional resources may be coupled to processor(s) 102 of IHS 100 through chipset 110. For instance, chipset 110 may be coupled to network interface 120 that may support different types of network connectivity. IHS 100 may also include one or more Network Interface Controllers (NICs) 122 and 124, each of which may implement the hardware required for communicating via a specific networking technology, such as BLUETOOTH, in accordance with various embodiments of the present systems and methods, wireless local area network (e.g., Wi-Fi™), Ethernet and mobile cellular networks (e.g., CDMA, TDMA, LTE). Network interface 120 may support network connections by wired network controllers 122 and wireless network controllers 124. Each network controller 122 and 124 may be coupled via various buses to chipset 110 to support different types of network connectivity, such as the network connectivity utilized by IHS 100. Wireless Local Area Networks (WLANs) (e.g., IEEE 802.11ax, 6E Wi-Fi™) may be the subject of embodiments of the present systems and methods for interference avoidance for high density ad hoc wireless networks, and the like. For example, a plurality of laptop IHSs, or the like, may be wirelessly linked via WLANs (e.g., IEEE 802.11ax, 6E Wi-Fi™) with respect to wireless docking station IHSs in a hybrid workspaces office setting in high density ad hoc networks, and embodiments of the present systems and methods may be used to provide interference avoidance.

As illustrated, IHS 100 may support integrated display device 126, such as a display integrated into a terminal, laptop, tablet, 2-in-1 convertible device, or mobile device. IHS 100 may also support use of one or more external displays 128, such as external monitors that may be coupled to IHS 100 via various types of couplings, such as by connecting a cable from the external display 128 to external I/O port 128 of the IHS 100. One or more display devices 126 and/or 128 coupled to IHS 100 may utilize LCD, LED, OLED, or other display technologies. Each display device 126 and 128 may be capable of receiving touch inputs such as via a touch controller that may be an embedded component of display device 126 and/or 128 or graphics processor 130, or it may be a separate component of IHS 100 accessed via bus 112. In some cases, power to graphics processor 130, integrated display device 126 and/or external display 128 may be turned off or configured to operate at minimal power levels in response to IHS 100 entering a low-power state (e.g., standby). Chipset 110 may provide access to one or more display device(s) 126 and/or 128 via graphics processor 130. Graphics processor 130 may be included within a video card, graphics card or within an embedded controller installed within IHS 100. Additionally, or alternatively, graphics processor 130 may be integrated within processor(s) 102, such as a component of a system-on-chip (SoC). Graphics processor 130 may generate display information and provide the generated information to one or more display device(s) 126 and/or 128, coupled to IHS 100.

Chipset 110 also provides processor(s) 102 with access to one or more storage devices 132. In various embodiments, storage device 132 may be integral to IHS 100 or may be external to IHS 100. In certain embodiments, storage device 132 may be accessed via a storage controller that may be an integrated component of the storage device. Storage device 132 may be implemented using any memory technology allowing IHS 100 to store and retrieve data. For instance, storage device 132 may be a magnetic hard disk storage drive or a solid-state storage drive. In certain embodiments, storage device 132 may be a system of storage devices, such as a cloud system or enterprise data management system that is accessible via network interface 120.

As illustrated, IHS 100 also includes Basic Input/Output System (BIOS) 134 that may be stored in a non-volatile memory accessible by chipset 110 via bus 112. Upon powering or restarting IHS 100, processor(s) 102 may utilize BIOS 134 instructions to initialize and test hardware components coupled to the IHS 100. BIOS 134 instructions may also load an OS (e.g., WINDOWS, MACOS, IOS, ANDROID, LINUX, etc.) for use by IHS 100. BIOS 134 provides an abstraction layer that allows the operating system to interface with the hardware components of the IHS 100. The Unified Extensible Firmware Interface (UEFI) was designed as a successor to BIOS. As a result, many IHSs utilize UEFI in addition to or instead of a BIOS. As used herein, BIOS is intended to also encompass UEFI. IHS firmware (UEFI or BIOS), or the like, may enable a user to configure a “boot order.” The IHS will try to boot from a first indicated device, and if this fails, the IHS will attempt to boot from the next indicated device, etc.

As illustrated, certain IHS 100 embodiments may utilize sensor hub 136 capable of sampling and/or collecting data from a variety of hardware sensors 138. Sensors may provide access to data describing environmental and operating conditions of IHS 100 (e.g., accelerometers, gyroscopes, hinge sensors, rotation sensors, hall effect sensors, temperature sensors, voltage sensors, current sensors, IR sensors, photosensors, proximity sensors, distance sensors, magnetic sensors, microphones, ultrasonic sensors, etc.). Generally, in various implementations, processor 102 may receive and/or produce context information using sensors 138 including one or more of, for example: a user's presence state (e.g., present, near-field, mid-field, far-field, absent), a facial expression of the user, a direction of the user's gaze, a user's gesture, a user's voice, an IHS location (e.g., based on the location of a wireless access point or Global Positioning System), IHS movement (e.g., from an accelerometer or gyroscopic sensor), lid state (e.g., of a laptop), hinge angle (e.g., in degrees), IHS posture (e.g., laptop, tablet, book, tent, and display), whether the IHS is coupled to a dock or docking station, a distance between the user and at least one of: the IHS, the keyboard, or a display coupled to the IHS, a type of keyboard (e.g., a physical keyboard integrated into IHS 100, a physical keyboard external to IHS 100, or an on-screen keyboard), whether the user operating the keyboard is typing with one or two hands (e.g., holding a stylus, or the like), a time of day, software application(s) under execution in focus for receiving keyboard input, whether IHS 100 is inside or outside of a carrying bag, ambient lighting, a battery charge level, whether IHS 100 is operating from battery power or is plugged into an AC power source (e.g., whether the IHS is operating in AC-only mode, DC-only mode, or AC+DC mode), a power consumption of various components of IHS 100 (e.g., CPU 102, GPU 130, system memory 104, etc.), an operating temperature of components of IHS 100, such as CPU temperature, memory module temperature, etc. In certain embodiments, sensor hub 136 may be an independent microcontroller or other logic unit that is coupled to the motherboard of IHS 100. Sensor hub 136 may be a component of an integrated system-on-chip incorporated into processor 102, and it may communicate with chipset 110 via a bus connection such as an Inter-Integrated Circuit (I2C) bus or other suitable type of bus connection. Sensor hub 136 may also utilize an I2C bus for communicating with various sensors supported by IHS 100.

As illustrated, IHS 100 may utilize embedded controller (EC) 140, which may be a motherboard component of IHS 100 and may include one or more logic units. In certain embodiments, EC 140 may operate from a separate power plane from the main processors 102 and thus the OS operations of IHS 100. Firmware instructions utilized by EC 140 may be used to operate a secure execution system that may include operations for providing various core functions of IHS 100, such as power management, management of operating modes in which IHS 100 may be physically configured and support for certain integrated I/O functions. In some embodiments, EC 140 and sensor hub 136 may communicate via an out-of-band signaling pathway or bus 124.

In various embodiments, IHS 100 may not include each of the components shown in FIG. 1. Additionally, or alternatively, IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 102 as an SoC.

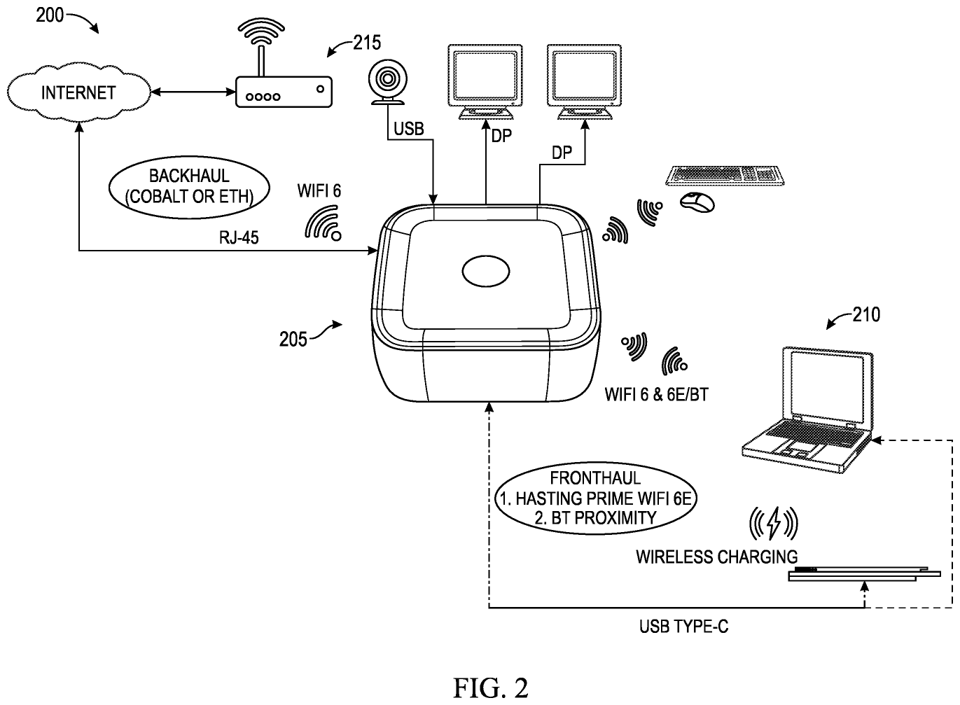

One key enabler of a modern “intelligent” office, (i.e., a hoteling, or hybrid, office workspace) may include wireless docking solutions where, for example, a laptop automatically connects to a wireless docking station (“dock”) as the user approaches the dock, a dock-linked external displays lights up and is ready for use when the user (i.e., the laptop) arrives at the dock. FIG. 2 is a block diagram showing key components of such an intelligent hybrid office workspace (200), according to some embodiments. As noted, central to this solution is wireless dock 205 and laptop 210. In various embodiments of such an intelligent hybrid office workspace an ability to accurately measure the relative distance between dock 205 and laptop 210 enables, waking of dock 205 and the dock making connection in such a timeframe, so that dock 205 and connected devices are ready for use when the user (i.e., the laptop) arrives at the dock.

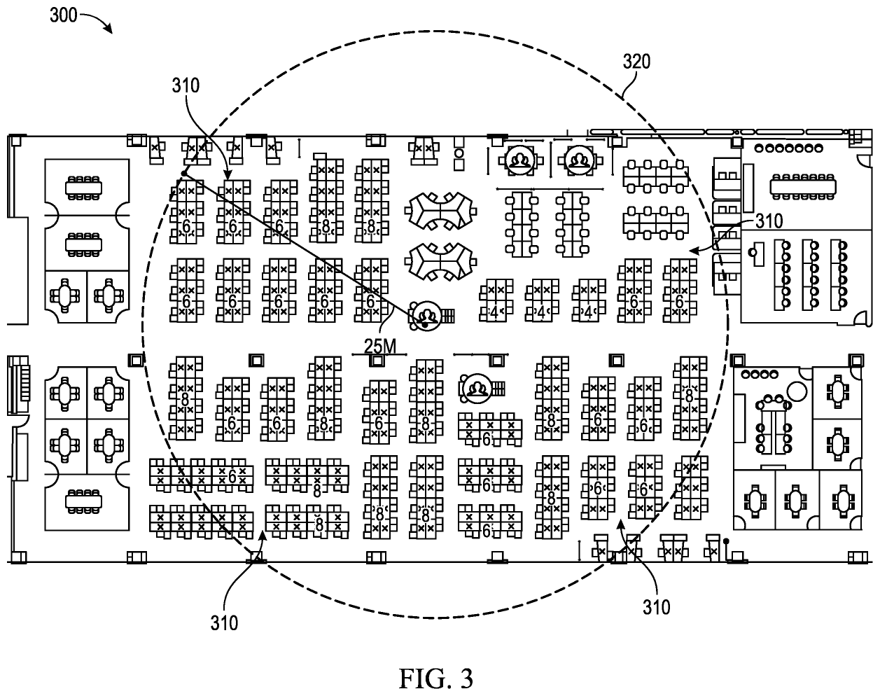

As discussed above, each wireless dock in a hybrid workspaces office setting results in an additional WLAN link, which is in addition to the WLAN link from Access Points (APs) 215 in an enterprise environment employing intelligent hybrid office workspaces 200. A sample office space, such as sample hybrid workspaces office space 300 of FIG. 3, may have, by way of example, as many as 230 seats (reference number(s) 310) within wireless range (e.g., 25 m) (reference number 320) when employing Wi-Fi® 6E. High bandwidth needs for video data over WLAN link may need a high Bandwidth link and may typically need a 160 MHz link, such as may be provided in accordance with Wi-Fi® 6E. . . . In such an example, a maximum of twelve nonoverlapping channels would be available under Wi-Fi® 6E, assuming complete bandwidth is available. Still the number of concurrent channels needed is much higher for typical hybrid office workspaces. See, for example Table 1, below.

TABLE 1

| | |
|---|---|
| Seats | 230 |
| Upgraded To Auto Wireless | 50% |
| Docking | |
| Auto Wireless Docking | 115 |
| Workspaces | |
| Occupancy | 60% |
| Total Users | 69 |

As noted, reducing transmit (Tx) power of the radio on both sides of the link would be atypical approach to a solution. However, only limited controls for TX power are available under a typical operating system. Further, as noted reducing Tx power limits the device connectivity with infrastructure and challenges the signal-to-noise ratio (SNR) of the signal in such a high-interference environment.

Embodiments of the present systems and methods provide solutions for high density WLAN operation. Therein, interference avoidance for high density ad hoc networks may be implemented by creating ad hoc WLAN clusters (WLAN pico-nets) of IHSs with nonoverlapping channels, enabling each IHS to have a high bandwidth wireless interface, and isolating nearby ad hoc WLAN clusters, using a Basic Secure Set (BSS) color field to associate IHSs within an ad hoc WLAN cluster (which may be preconfigured for each ad hoc WLAN cluster). Physical separation of ad hoc WLAN clusters may be optimized, minimizing cochannel interference, such as through use of dynamic threshold calculations. Nearby ad hoc WLAN clusters may be further isolated by dynamically adjusting transmit power control to isolate nearby ad hoc WLAN clusters, and/or by scaling channel width, such as through Dynamic Throughput Scalar (DTS) calculations.

Embodiments of the present systems and methods make use of Wi-Fi® 6E capability and WLAN pico-net creation in accordance with embodiments of the present systems and methods, as discussed in greater detail below. Historically, WLANs have (e.g., Wi-Fi® has) operated in the 2.4 GHz and 5 GHz spectrum bands. With standardization of Wi-Fi® 6E, spectrum of 1200 MHz has been added at 6 GHz, resulting in 59 new channels at 20 MHz, to 6 new channels at 160 MHz, as tabulated in Table 2, below. Ability to combine these channels into wider channels is also supported under IEEE 802.11ax, the Wi-Fi® 6E standard.

TABLE 2

| | Number of | Bandwidth per | |
|---|---|---|---|
| Band | Channels | Channel | |
| 2.4 GHz | 3 | 20 | MHz |
| 5 GHz | 25 | 20 | MHz |
| | 12 | 40 | MHz |
| | 6 | 80 | MHz |
| | 2 | 160 | MHz |
| 6 GHz | 59 | 20 | MHz |
| | 29 | 40 | MHz |
| | 14 | 80 | MHz |
| | 6 | 160 | MHz |

Thus, in accordance with the foregoing, 69 or more channels may be needed in a hybrid office workspace, but only twelve channels may be available (or six channels at 160 MHz), even under Wi-Fi® 6E. This need will only increase with continued adoption of hybrid office workspaces, and no new spectrum availability is on the horizon.

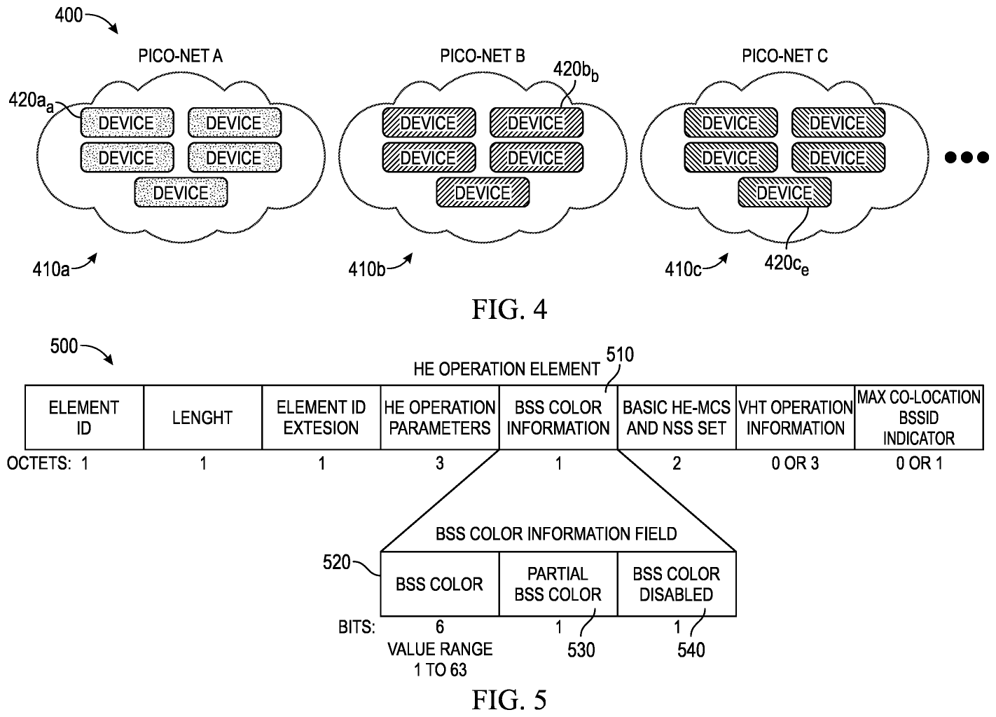

For an application like wireless docks, an additional WLAN is added for each cubicle. Given that a finite number of overlapping channels are available, embodiments of the present systems and methods may “cluster” a set of nearby devices where each device can use a non-overlapping channel. These clusters are referred to herein as “WLAN pico-nets,” which are ad-hoc WLAN clusters, under Wi-Fi® 6E. FIG. 4 is a diagrammatic example of such a set (400) of WLAN pico-nets 410a-n. Devices 420aₐ though 420nₙ (e.g., IHS laptops (210), wireless docks (205), routers/APs (215), edge gateways, etc.) within a WLAN pico-net use a same BSS color, such as discussed in greater detail below. The WLAN pico-nets are separated from the adjacent WLAN pico-nets by using unique BSS color in the information element in the header of each WLAN packet. BSS color is defined as part of 802.11 networks, such as Wi-Fi® 6E WLANs. Under Wi-Fi® 6(E), BSS coloring enables devices to differentiate transmissions in their own network from transmissions in neighboring networks. However, in accordance with embodiments of the present systems and methods, a BSS color is a (6-bit) number for a particular WLAN pico-net.

FIG. 5 is a diagrammatic illustration of high efficiency operation element 500 which can be employed (in-part), by some embodiments of the present systems and methods. High efficiency operation element 500 may be added to frames for peer-to-peer (P2P) or “SoftAP” mode of operation. For example, high efficiency operation element 500 may be added to a beacon frame, a probe response frame a (re)association frame, or the like. Typically, a client device receives one or more of these frames, as part of each packet header, to maintain a WLAN connection. As shown in FIG. 5, high efficiency operation element 500 may, in accordance with embodiments of the present systems and methods, include BSS color information field 510, which may be comprised of BSS color bits (e.g., 6 bits) 520, which may have, by way of example a value range of one to 63, for all 64 pico-nets to be established. BSS color information field 510, may also include partial BSS color 530. This partial BSS color field can be used for extension of BSS color bits 520, by indicating that the 6-bit BSS color bit is partial and additional bits can send part of vendor-specific information in the WLAN Information Element (IE). Bit 540 may indicate whether BSS color is disabled (i.e., not used) (or active) for this packet.

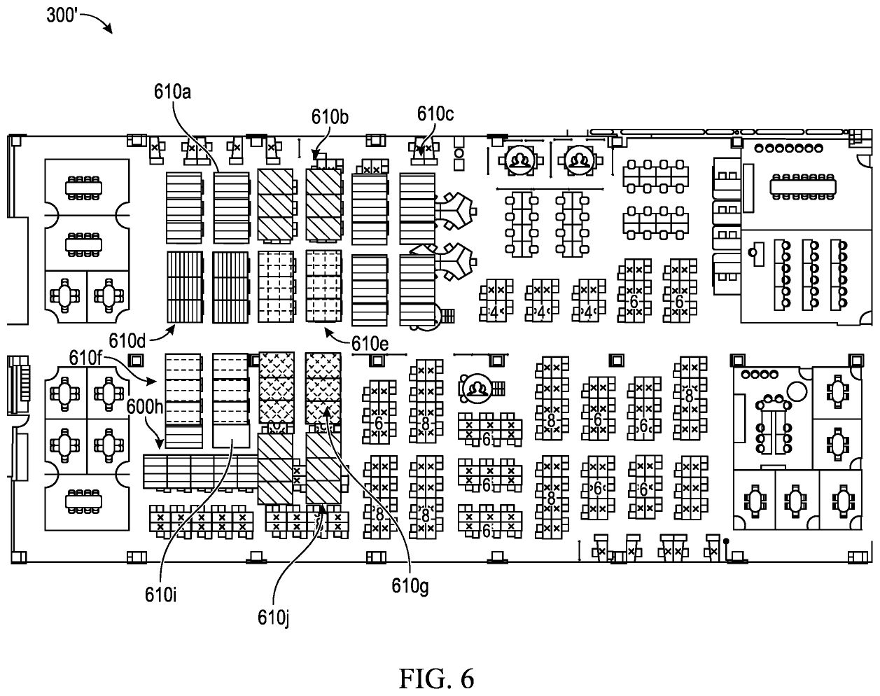

In accordance with the foregoing, FIG. 6 is a diagrammatic illustration of example hybrid workspaces office space 300′ of FIG. 3, showing multi-channel interference avoidance to provide interference avoidance for high density ad hoc networks using BSS colors for WLAN pico-nets 605a through n (605a through j illustrated), according to some embodiments.

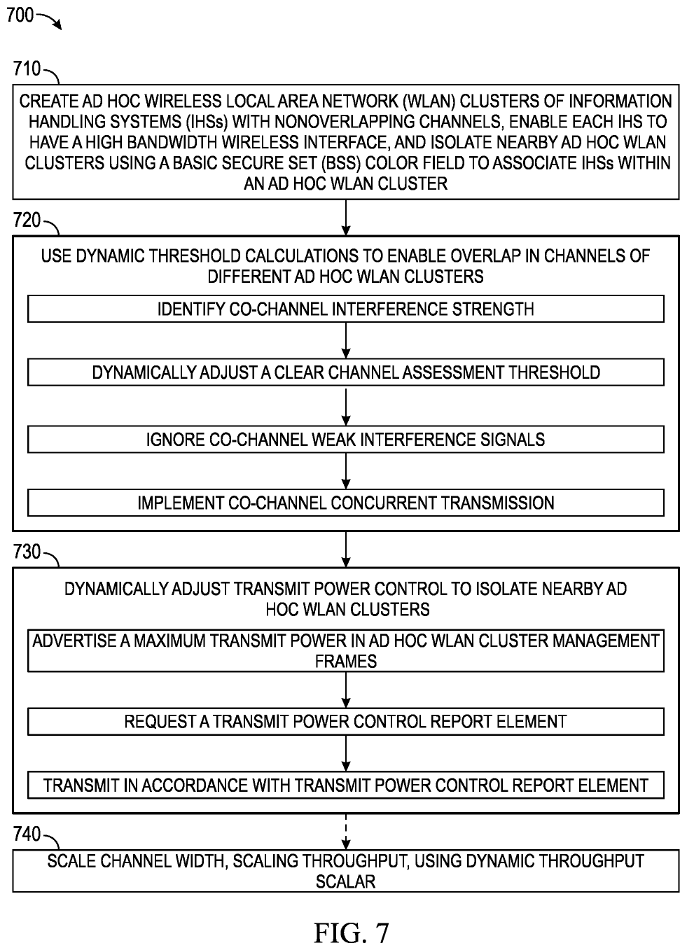

FIG. 7 is a flowchart of example process 700 for interference avoidance for high density ad hoc networks, according to some embodiments. For example, embodiments of the present systems and methods establish clusters of ad-hoc WLAN nodes where each node in the cluster uses a different non-overlapping channel for data transmission, at 710. The number of nodes in each cluster may be auto-configured based on the available frequency spectrum, or the like, in accordance with embodiments of the present systems and methods. Alternatively (or additionally, at least in part), The number of nodes in each cluster may be pre-configured, or the like, such as by an Information Technology (IT) manager, or the like. As discussed above, the plurality of clusters may be established at 710 using a 6-bit configuration bit number (i.e., a BSS Color) identifying the cluster. The nodes in different clusters are sufficiently spatially separated to enable self-generating WLAN pico-nets of P2P WLAN nodes (420) to enable high-bandwidth, high-density WLAN operation for applications, such as wireless docking, videoconferencing, and the like.

In accordance with embodiments of the present systems and methods, the WLAN pico-nets established at 710 may be pre-configured by IT managers, or each of the nodes can self-initiate to randomly configure its WLAN channel and BSS color to establish the WLAN pico-nets at 710. In either case, the P2P WLAN nodes (420) may be configured to support the WLAN pico-net (410) creation at 710, and their use below. To such ends, embodiments of the present systems and methods may employ a capability in the WLAN nodes to support ad-hoc WLAN clusters in the vendor-specific IE during association to establish the WLAN (e.g., Wi-Fi® Direct

Connectivity, under Wi-Fi® 6E. Alternatively, or additionally, embodiments of the present systems and methods may employ a capability in the WLAN nodes to support ad-hoc WLAN clusters that may be added to a Soft-AP association and bonding process, such as [[WHAT?]]. Thereby, the ad-hoc WLAN cluster capability described above is used to enable ad-hoc WLAN cluster high density operation of P2P WLAN nodes in accordance with embodiments of the present systems and methods,

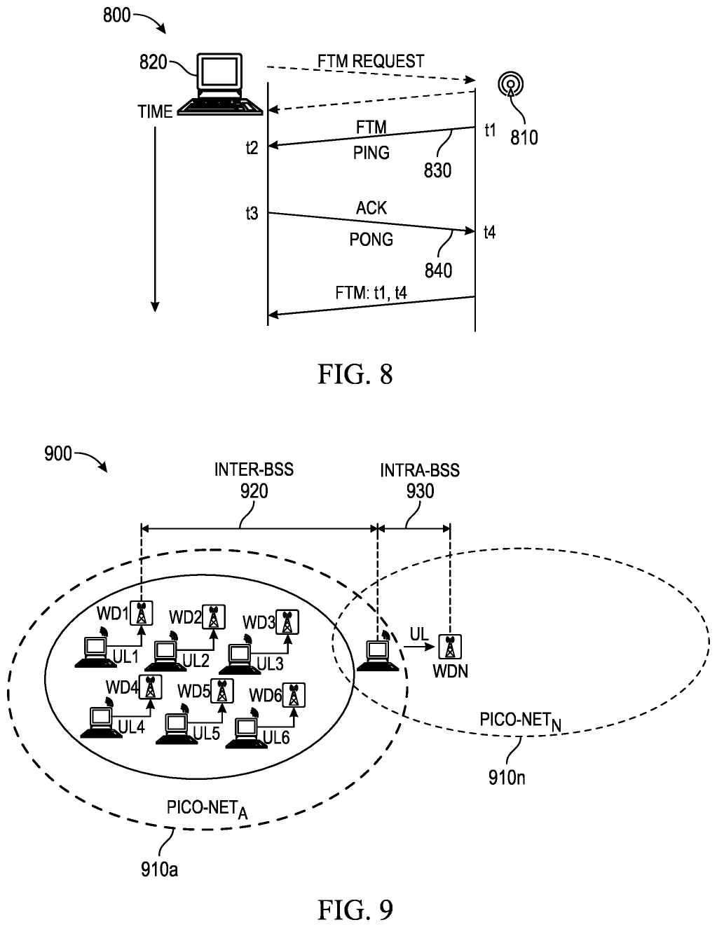

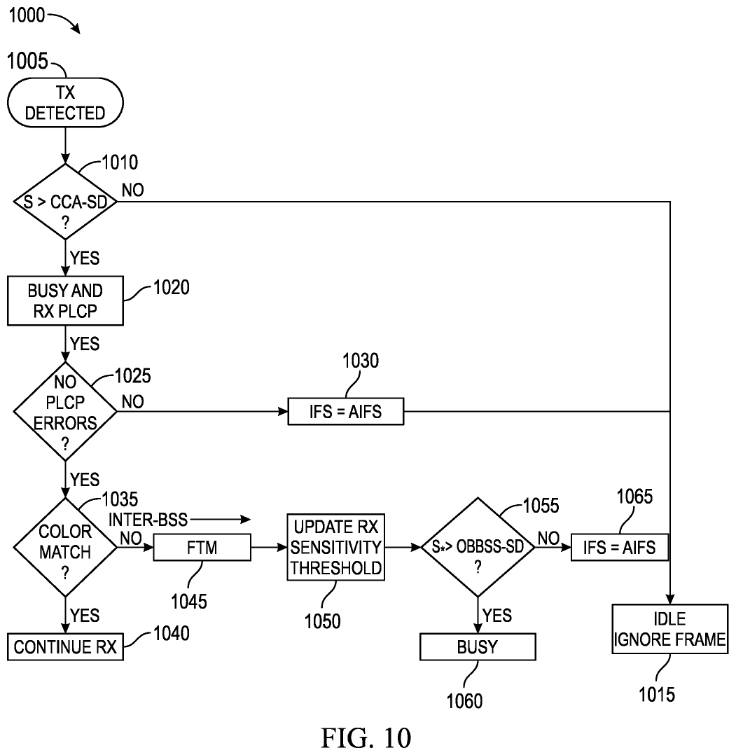

At 720, in further support of use of the clusters of ad-hoc WLAN nodes, and as further described below, co-channel interference strength is identified, and a Clear Channel Assessment (CCA) threshold is dynamically adjusted. This threshold may be calculated using Fine Timing Measurement (FTM) as discussed below, with respect to FIGS. 8 and 9. Thereafter, weak co-channel interference signals may be ignored, and co-channel concurrent transmission is implemented, per FIG. 10. This increases system throughput.

In accordance with the foregoing, and as further detailed below, BSS coloring is used in accordance with embodiments of the present systems and methods to identify co-channel interference and is handled differently from a typical deferral under IEEE 802.11ax (Wi-Fi® 6(E)). Under embodiments of the present systems and methods a device (420) is enabled to continue to transmit on a same channel, which allows for spatial reuse. As discussed in greater detail below, with respect to FIG. 10, when a signal is detected as an overlapping BSS (“OBSS”), but with lower signal strength, the station (i.e., receiving device) can reduce a receiving (Rx) threshold to a higher value (e.g., to −62 dBm from −82 dBm), and continue to receive and transmit data, to thereby ignore weak co-channel interference signals and implement co-channel concurrent transmission, at 720. Thereby, under embodiments of the present systems and methods, adaptive clear channel assessment may be used to raise Signal Detect (SD) threshold for inter-BSS frame while maintaining a lower threshold for Intra-BSS frame.

In accordance with various embodiments of the present systems and methods, lower power consumption and WLAN pico-net isolation may be achieved by implementing dynamic Tx Power Control (TPC) at 730. In accordance with embodiments of the present systems and methods, TPC can be carried out using the RSSI (Relative signal strength indicator) information or SNR. If RSSI is high, Tx power level can be reduced and vice-versa. For example, a maximum transmit power may be advertised in management frames (e.g., in beacons and/or probe response frames), the IEEE 802.11ax (Wi-Fi® 6(E)) TPC Report element, a frame that holds information about the current transmit power and link margin, may be requested, then transmitting in accordance with the TPC Report element. Under embodiments of the present systems and methods, these control and management frames are sent using the highest allowable transmit power level and all the statistics obtained are held and implemented on a per associated node-basis. Thereby, in accordance with embodiments of the present systems and methods, dynamic TPC at 730 does not involve the device OS, an application program, or the like. Thusly, in embodiments of the present systems and methods, the TPC is dynamically managed, at 730, depending on environmental conditions, such as, interference from another WLAN network or other radio activity.

In implementation of the foregoing, the WLAN pico-nets, established at 710, may be pre-configured by IT managers. For example, Information Technology Decision Makers (ITDMs) can configure the WLAN pico-nets based on pre-defined criteria, which may be based on target throughput needs and device density for a particular office space (300 qua 300′). Additionally, a throughput calibration procedure can be applied to adapt to needs of an enterprise employ embodiments of the present systems and methods for interference avoidance for such high density ad hoc networks. For example, interference triggered self-calibration may be implemented in accordance with embodiments of the present systems and methods by gathering telemetry on packet loss, Clear Channel Assessment (CCA) reports, Bandwidth loss, and the like.

Also, as discussed below, isolating nearby ad hoc WLAN clusters may further involve scaling channel width, at 740, thereby scaling throughput, such as by implementation of a dynamic throughput scalar process. Therein, a telemetry and statistics-based throughput calibration procedure can be used to detect the transmission rate achieved with the configuration, providing information on spectrum scaling needs, such as discussed below. Such calibration may be made periodically, such as nightly, and/or on-demand, for example, to allow for new nodes to be added in a random fashion. Additionally, or alternatively, calibration can be remotely triggered for managed devices (420).

As noted, the threshold employed at 720 may be calculated using FTM. FIG. 8 is a diagrammatic illustration of FTM 800 enabled in IEEE 802.11ax (Wi-Fi® 6(E)), and FIG. 9 is a diagrammatic illustration of example implementation 900 of dynamic threshold calculation, in accordance with some embodiments of the present systems and methods for interference avoidance for high density ad hoc networks.

In FIG. 8, distance from WLAN AP 810 to WLAN device 820 is calculated using FTM according to the formula:

2*distance=((t4-t1)−(t3-t2))*c

Therein, the total round trip time from initial FTM ping 830 from AP 810 to receipt at the Ap of acknowledging “pong” 840 (t4-t1), less the turnaround time from receiving Ping 830 at device 820 and issuing of pong 840 (t3-t2), times c (the speed of light), renders twice the distance between WLAN AP 810 and WLAN device 820. Turning to FIG. 9, since the channels within each WLAN pico-net (910a through n), such as between each User Laptop (UL) and a respective Wireless Doc (WD), are non-overlapping, a threshold of inter-channel BSS 920 and intra-channel BSS 930 can be calculated and configured based on FTM 800, such as further detailed in FIG. 10.

FIG. 10 is a flowchart of example dynamic sensitivity control 1000, such as may be derived using FTM 800, and inter-channel BSS 920 and intra-channel BSS 930, from FIGS. 8 and 9, according to some embodiments. At 1005, a station (i.e., client device (420, 810, 820) detects RF energy, such as from a transmission. At 1010 a Clear Channel Assessment (CCA) (under IEEE 802.11ax (Wi-Fi® 6(E)) is made as to whether energy threshold(S) of the transmission is above (i.e., greater than) a CCA SD threshold (e.g., −82 dBm) or below (i.e., less than). If the energy threshold(S) of the transmission is below the CCA SD threshold (e.g., −82 dBm), process 1000 idles at 1015 and the transmission (frame) is ignored (per 720, above).

If, it is determined at 1010 that the energy threshold(S) (RSSI) of the transmission is greater than the CCA SD threshold (e.g., −82 dBm), the station checks at 1020 whether it can demodulate the traffic (i.e., the transmission), such as whether the station is already busy and/or based on the received transmission's Physical Layer Convergence Protocol (PLCP) indicated data rate and/or packet length. If the station can demodulate the traffic the station determines, at 1025, if there are no PLCP (data rate and packet length) errors in the transmission. If there are PLCP errors in the transmission, The Interframe Space (IFS) for frames of the transmission are extend to an Extended Interframe Space (EIFS) to accommodate retransmission and process 1000 idles at 1015 and the initial transmission (frame) is ignored (per 720, above).

If it is determined at 1025 are no PLCP (data rate and packet length) errors in the transmission, the station will read the transmission packet's frame header (e.g., high efficiency operation element 500) at 1035 to determine the BSS color (510/520) of the frame. If it is determined at 1035 that the BSS color of the transmission (frame) is the same as the BSS color assigned to the station, it means the transmission (frame) is intra-channel BSS (930) and receipt of the transmission (frame) will continue at 1040, going through the normal Carrier-Sense Multiple Access with Collision Avoidance (CSMA/CA) process, in accordance with IEEE 802.11ax (Wi-Fi® 6(E).

However, if it is determined at 1035 that the BSS color of the transmission (frame) is not the same as the BSS color assigned to the station, then the transmission (frame) is treated as an inter-channel BSS (920) transmission (frame) and an FTM calculation is carried out on the transmission (frame), at 1045, to update the transmission's (frame's) sensitively threshold (OBSS SD threshold, e.g., −72 dBm) at 1050. At 1055, another threshold check is made to determine if the energy threshold (S′) (signal strength of the transmission (frame)) is above this transmission (frame) sensitively threshold (OBSS SD threshold, e.g., −72 dBm). If the energy threshold (S′) is above the transmission (frame) sensitively threshold (OBSS SD threshold, e.g., −72 dBm) the transmitting station is too close and the wireless medium will be considered as busy, at 1060. However, if it is determined at 1055 that signal strength (S′) (of the transmission (frame)) is below the transmission (frame) sensitively threshold (OBSS SD threshold, e.g., −72 dBm) signal strength, the station will not contend for this transmission and will continue transmitting.

In accordance with various embodiments of the present systems and methods, Dynamic Throughput Scalar (DTS) (calculations) may use two thresholds, “successThreshold” and “failThreshold,” that correspond to a minimum number of consecutive successful and failed transmissions, respectively, before selection of a new data rate. Using these two thresholds, various embodiments of the present systems and methods, achieve stability and prevent use of an inappropriate data rate.

Under IEEE 802.11 (ax (Wi-Fi® 6(E)), frame aggregation increases throughput by sending multiple data frames in a single transmission, Transmit Opportunity (TxOP) increases throughput for high priority data by providing contention-free channel access for a period of time, and the Block Ack mechanism improves channel efficiency by aggregating several acknowledgments into one frame. Embodiments of the present systems and methods may scale channel width, thereby scaling throughput. In accordance with DTS under embodiments of the present systems and methods, a transmission is considered successful when, in the case of non-aggregation, the transmission is acknowledged, and when, in the case of the Block-Ack mechanism (under aggregation and TxOP), enough packets have been successfully delivered. For the latter case, the success rate threshold may be expressed in terms of percent, which determines the outcome of the transmission under Block Ack (success or not). For example, if ten packets are aggregated and eight of them have been correctly received, is the success threshold is 80, the transmission will be defined as successful.

Furthermore, DTS my, in accordance with embodiments of the present systems and methods, keep historical data for a specific rate per node and may calculate per interval (e.g., 100 ms) and per cycle (where the cycle>interval, e.g., 1 second when the overlapping OBSS SD is updated (e.g., at 1050, above)). For example, the following data may be gathered: “intervalRateSuccess,” the number of packets succeeded per interval; “intervalRateTxFrames,” the total number of the packets transmitted per interval; “numRateTxFrames,” the number of packets transmitted per cycle; “numRateTxAttempts,” the total number of transmission attempts (aggregated frame transmission is considered as one) per cycle; and “throughput,” based on the packets transmitted and the success rate per interval and smoothed out, according to a moving average. In accordance therewith, “dtsProb,” is the success rate probability based on the success rate per interval and smoothed out with the Exponential Weighted Moving Average, and may be calculated using the equation:

$$dtsProb = \frac{SuccessProTrans * ( 100 - dtsLevel ) + dtsProb * dtsLevel}{100}$$

$$where the dtsLevel is the Exponential Weighted Moving Average ( e . g . , dtsLevel = 90 ) and$$

$$SuccessProbTrans = 100 * \frac{intervalRateSuccess}{IntervalRateTXFrames}$$

In accordance with embodiments of the present systems and methods, the throughput and dtsProb variables are initialized to zero during the association/dissociation or after long periods of inactivity.

In various embodiments, aspects of systems and methods described herein may be implemented, at least in part, using machine learning (ML) and/or artificial intelligence (AI). As but one example, dtsProb can be enhanced using ML, such as by applying information from historical data, and/or the like. More particularly, ML may, in accordance with some embodiments, use a historical record of devices that are statically present in an ad hoc network and those that come and go periodically. Such a historical record many be used, in accordance with such embodiments to accelerate configuration of ad hoc WLAN clusters and provide consistency over time for devices that are close to the boundaries of the ad hoc WLAN cluster, for example, such that the devices could “flip” between different ad hoc WLAN clusters.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

For example, in various implementations of embodiments of the present systems and methods, an IHS may implement interference avoidance in a high density ad hoc network, such as by joining an ad hoc WLAN cluster (WLAN pico-net) of IHSs with nonoverlapping channels isolated from other nearby ad hoc LAN clusters by a BSS color field to associate IHSs within the ad hoc WLAN cluster. Physical separation of the ad hoc WLAN clusters may be optimized, minimizing cochannel interference, such as by using dynamic threshold calculations, such as in the manner described above with respect to FIG. 8 though 10. Nearby ad hoc WLAN clusters may also be (further) isolated by dynamically adjusting transmit power control TPC, as also discussed above. Additionally, nearby ad hoc WLAN clusters may, in some embodiments, be (further) isolated by scaling channel width, such as through the use of DTS, as described above.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As noted, in various embodiments, aspects of the above-described systems and methods may be implemented, at least in part, using machine learning (ML). As used herein, the terms “machine learning” or “ML” refer to one or more algorithms that implement: a neural network (e.g., artificial neural network, deep neural network, convolutional neural network, recurrent neural network, autoencoders, reinforcement learning, etc.), fuzzy logic, artificial intelligence (AI), deep learning, deep structured learning hierarchical learning, support vector machine (SVM) (e.g., linear SVM, nonlinear SVM, SVM regression, etc.), decision tree learning (e.g., classification and regression tree or “CART”), Very Fast Decision Tree (VFDT), ensemble methods (e.g., ensemble learning, Random Forests, Bagging and Pasting, Patches and Subspaces, Boosting, Stacking, etc.), dimensionality reduction (e.g., Projection, Manifold Learning, Principal Components Analysis, etc.), or the like.

Non-limiting examples of publicly available ML algorithms, software, and libraries that may be utilized within embodiments of systems and methods described herein include, but are not limited to: PYTHON, OPENCV, INCEPTION, THEANO, TORCH, PYTORCH, PYLEARN2, NUMPY, BLOCKS, TENSORFLOW, MXNET, CAFFE, LASAGNE, KERAS, CHAINER, MATLAB Deep Learning, CNTK, MatConvNet (a MATLAB toolbox implementing convolutional neural networks for computer vision applications), DeepLearnToolbox (a Matlab toolbox for Deep Learning from Rasmus Berg Palm), BigDL, Cuda-Convnet (a fast C++/CUDA implementation of convolutional or feed-forward neural networks), Deep Belief Networks, RNNLM, RNNLIB-RNNLIB, matrbm, deeplearning4j, Eblearn.Ish, deepmat, MShadow, Matplotlib, SciPy, CXXNET, Nengo-Nengo, Eblearn, cudamat, Gnumpy, 3-way factored RBM and mcRBM, mPoT, ConvNet, ELEKTRONN, OpenNN, NEURALDESIGNER, Theano Generalized Hebbian Learning, Apache SINGA, Lightnet, and SimpleDNN.”

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. A method of interference avoidance for high density ad hoc networks, the method comprising:
creating ad hoc Wireless Local Area Network (WLAN) clusters of Information Handling Systems (IHSs) with nonoverlapping channels;
enabling each IHS to have a high bandwidth wireless interface; and
isolating nearby ad hoc WLAN clusters, using a Basic Secure Set (BSS) color field to associate IHSs within an ad hoc WLAN cluster.

2. The method of claim 1, wherein each ad hoc WLAN cluster is a WLAN pico-net.

3. The method of claim 1, wherein the BSS color is preconfigured for each ad hoc WLAN cluster.

4. The method of claim 1, further comprising optimizing physical separation of ad hoc WLAN clusters, minimizing cochannel interference.

5. The method of claim 4, wherein optimizing physical separation of ad hoc WLAN clusters uses dynamic threshold calculations.

6. The method of claim 5 wherein optimizing physical separation of ad hoc WLAN clusters using dynamic threshold calculations enables overlap in channels of different ad hoc WLAN clusters.

7. The method of claim 6, wherein optimizing physical separation of ad hoc WLAN clusters using dynamic threshold calculations enabling overlap in channels of different ad hoc WLAN clusters enables IHSs to operate and avoid randomly backing off.

8. The method of claim 1, wherein isolating nearby ad hoc WLAN clusters further comprises dynamically adjusting transmit power control to isolate nearby ad hoc WLAN clusters.

9. The method of claim 8 wherein transmit power control further comprises:
advertising a maximum transmit power in ad hoc WLAN cluster management frames;
requesting, by an ad hoc WLAN cluster node IHS, a transmit power control report element; and
transmitting, by the same, or another, a hoc WLAN cluster node IHS, in accordance with the transmit power control report element.

10. The method of claim 9, wherein the ad hoc WLAN cluster management frames comprise one or more of beacons and probe responses.

11. The method of claim 9, wherein ad hoc WLAN cluster management frame statistics obtained are held on a per associated ad hoc WLAN cluster node IHS basis.

12. The method of claim 9, wherein the control and management frames are sent using a highest allowable transmit power level.

13. The method of claim 9, wherein the transmit power control report element comprises a frame that holds information about the transmit power and a link margin.

14. The method of claim 9, wherein transmit power control is performed independent of an operating system of the ad hoc WLAN cluster node IHS.

15. The method of claim 9, wherein transmit power control is dynamically managed based on environmental conditions.

16. The method of claim 1, wherein isolating nearby ad hoc WLAN clusters further comprises scaling channel width.

17. The method of claim 16, wherein scaling channel width further comprises dynamic throughput scalar.

18. An Information Handling System (IHS) comprising:
at least one processor; and
a memory coupled to the at least one processor, the memory having program instructions stored thereon that, upon execution by the at least one processor, cause the IHS to:
implement interference avoidance in a high density ad hoc network, comprising:
joining an ad hoc Wireless Local Area Network (WLAN) cluster of IHSs with nonoverlapping channels, isolated from other nearby ad hoc LAN clusters by a Basic Secure Set (BSS) color field to associating IHSs within the ad hoc WLAN cluster;
optimizing physical separation of the ad hoc WLAN clusters, minimizing cochannel interference by using dynamic threshold calculations; and
isolating nearby ad hoc WLAN clusters, dynamically adjusting transmit power control.

19. The IHS of claim 18, wherein, upon execution by the processor, the program instructions further cause the IHS to isolate nearby ad hoc WLAN clusters by scaling channel width.

20. A non-transitory computer readable medium having program instructions stored thereon that, upon execution by one or more Information Handling Systems (IHSs), cause the one or more IHSs to:
create ad hoc Wireless Local Area Network (WLAN) clusters of IHSs with nonoverlapping channels;
enable each IHS to have a high bandwidth wireless interface;
isolate nearby ad hoc WLAN clusters, using a Basic Secure Set (BSS) color field to associate IHSs within an ad hoc WLAN cluster;
optimize physical separation of ad hoc WLAN clusters, minimizing cochannel interference; and
isolate nearby ad hoc WLAN clusters by dynamically adjusting transmit power control.
